(19) United States
(12) Patent Application Publication
(10) Pub. No.: US 2020/0226678 A1
(43) Pub. Date: Jul. 16, 2020

(54) Systems and Methods for Cryptographically Verifiable Ledgers with Predictive Outcome Generation

(71) Applicant: Walmart Apollo, LLC, Bentonville, AR (US)

(72) Inventors: Peter James Magnabosco, Bentonville, AR (US); Sid Shake, Rogers, AR (US)

(21) Appl. No.: 16/737,550

(22) Filed: Jan. 8, 2020

Related U.S. Application Data
(60) Provisional application No. 62/791,407, filed on Jan. 11, 2019.

(51) Int. Cl. G06Q 40/02; H04L 9/06; G06N 20/00

(52) U.S. Cl. CPC G06Q 40/025; H04L 9/0643; G06N 20/00; H04L 9/0637

(57) ABSTRACT

Described in detail herein is a predictive outcome generation system with blockchain controls. In one embodiment, the system includes a first computing system and one or more second computing systems configured to control operations associated with a request for a conditional event.

### RELATED APPLICATIONS

This application claims priority to and the benefit of U.S. Provisional Application No. 62/791,407, filed on Jan. 11, 2019, the disclosure of which is incorporated by reference herein in its entirety.

### BACKGROUND

A blockchain may generally refer to a distributed database that maintains a growing and ordered list or chain of records in which each block contains a hash of some or all previous records in the chain to secure the record from tampering and unauthorized revision. The blockchain may be managed in a peer-to-peer network or by a private entity.

### BRIEF DESCRIPTION OF THE FIGURES

Illustrative embodiments are shown by way of example in the accompanying figures and should not be considered as a limitation of the present invention. The accompanying figures, which are incorporated in and constitute a part of this specification, illustrate one or more embodiments of the invention and, together with the description, help to explain the invention. In the figures:

FIG. 1 is a block diagram of a database and machine learning engine in accordance with an exemplary embodiment;

FIG. 2 is a block diagram of an ether blockchain consortium design in accordance with an exemplary embodiment;

FIG. 3A-C depict exemplary processes in accordance with an exemplary embodiment;

FIG. 4 illustrates an exemplary network environment in accordance with an exemplary embodiment;

FIG. 5 depicts blocks in a blockchain as configured in accordance with an exemplary embodiment;

FIG. 6 depicts blockchain transactions in accordance with an exemplary embodiment;

FIG. 7 is a flowchart depicting a process performed in an exemplary embodiment;

FIG. 8 is a flowchart depicting a blockchain update in accordance with an exemplary embodiment;

FIG. 9 illustrates a block diagram of an exemplary computing device in accordance with an exemplary embodiment; and

FIG. 10 is a flowchart illustrating a process of the predictive outcome generation system using blockchain controls.

### DETAILED DESCRIPTION

Described in detail herein is a system with blockchain controls. In one embodiment, the system includes a first computing system configured to execute an instance of an application and store a cryptographically verifiable ledger represented by a sequence of data blocks. Each data block can contain one or more transaction records and each subsequent data block containing a hash value associated with a previous data block to link the data blocks in the sequence. The system can further include independently operated second computing systems. Each second computing system can be in communication with the first computing system, can be configured to execute an instance of the application, and can be configured to store a copy of a complete or partial version of the cryptographically verifiable ledger.

The first computing system can be configured to generate a first block in the cryptographically verifiable ledger including information associated with a request for a conditional event. The first block can include identification information corresponding to a user associated with the conditional event, and a date of the request to be satisfied. The first computing system can be further configured to generate a second block in the cryptographically verifiable ledger including information associated with a logic data structure for the conditional event. The second block can include a hash value associated with the first block and constraints associated with the logic data structure for the conditional event. The first computing system can further be configured to transmit an alert of the creation of the first block and second block to each of the second computing systems. One or more of the second computing systems can be configured to generate, via the application, subsequent blocks in the cryptographically verifiable ledger including information associated with the logic data structure for the conditional event or the user requesting the conditional event. The one or more of the plurality of second computing systems or the first computing system can be configured to predict, via the application, a user specific value associated with the user requesting the conditional event based on the subsequent blocks in the cryptographically verifiable ledger; trigger an action associated with the logic data structure based on the user specific value: and generate additional blocks in the cryptographically verifiable ledger including the user specific value and the triggered action.

In embodiment, each of the independently operated second computing systems can be configured to store, receive, and transmit information of a different type. Conditions of the conditional event can include a requirement of one or more responsive events in response to the conditional events and a date and time of execution of the responsive events. The user specific value can be associated with a likelihood that the one or more responsive events will be timely executed.

The action associated with the logic data structure can be one or more of: executing the logic data structure, modification of the logic data structure, voiding the logic data structure, and/or creating a new logic data structure. The constraints can include a verification of the information in the additional blocks including the user specific value by one or more of the second computing systems or the first computing system. The one or more of the independently operated second computing systems or the first computing system can be configured to generate new blocks in the cryptographically verifiable ledger including information associated with one or more responsive events. The constraints can include a confirmation of the execution of the one or more responsive events by the one or more of the second computing systems or the first computing system.

The one or more of the independently operated second computing systems and the first computing system are configured to predictively generate the user specific value using a predictive analysis based on the information in the first block, second block and the subsequent blocks. The one or more of the independently operated second computing systems and the first computing system are configured to predictively generate the user specific value each time each subsequent block is generated.

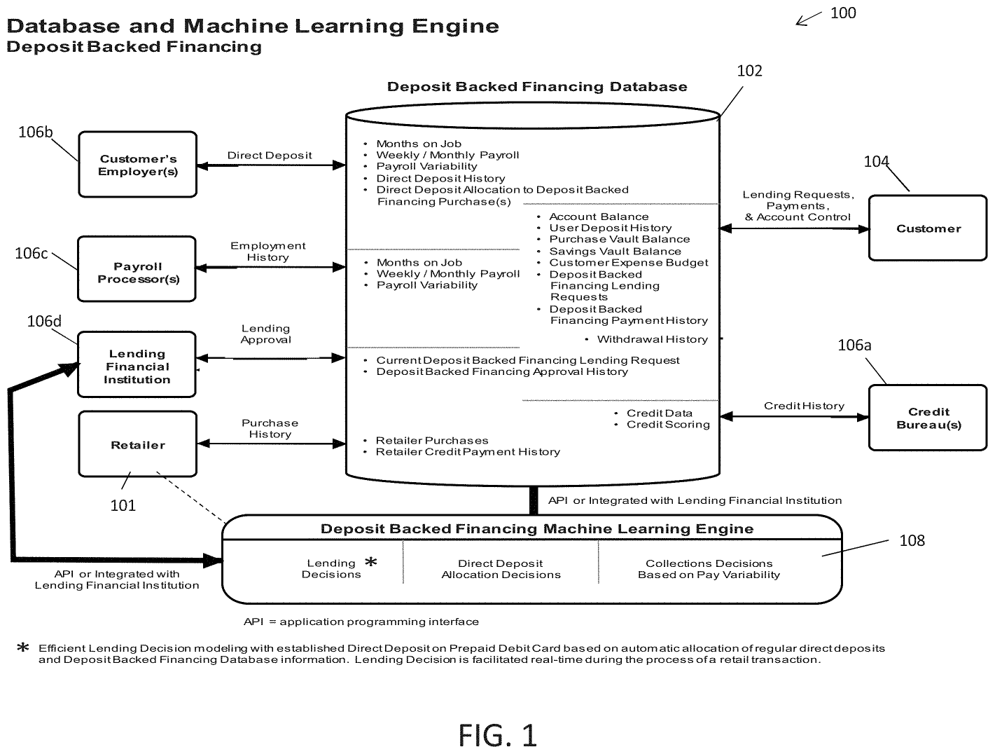

FIG. 1 is a block diagram of a database and machine learning engine 100 in accordance with an exemplary embodiment. The database and machine learning engine 100 can include a first computing system 101, a data storage facility 102, a user device 104, independently operated second computing systems 106a-d, and a machine learning engine 108. The first computing system 101, the user device 104, the independently operated second computing systems 106a-d, and/or the machine learning engine 108 can interface with the data storage facility 102. The first computing system 101, the user device 104, and/or the independently operated computing systems 106a-d can stream data associated with a user of the user device 104 into the data storage facility 102, as the data is received by each of the first computing system 101, the user device 104, and/or the independently operated computing systems 106a-d. The machine learning engine 108 can interface with the data storage facility 102 or one or more of the independently operated second computing systems 106a-d using an Application Program Interface (API). In one embodiment, the machine learning engine 108 can be included in the first computing system 101.

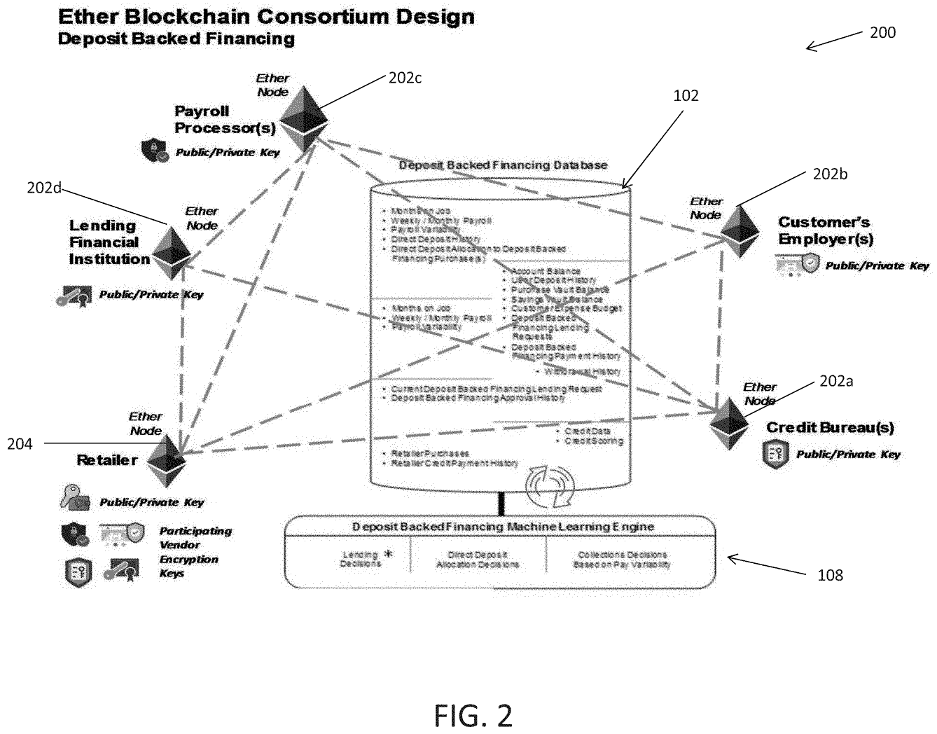

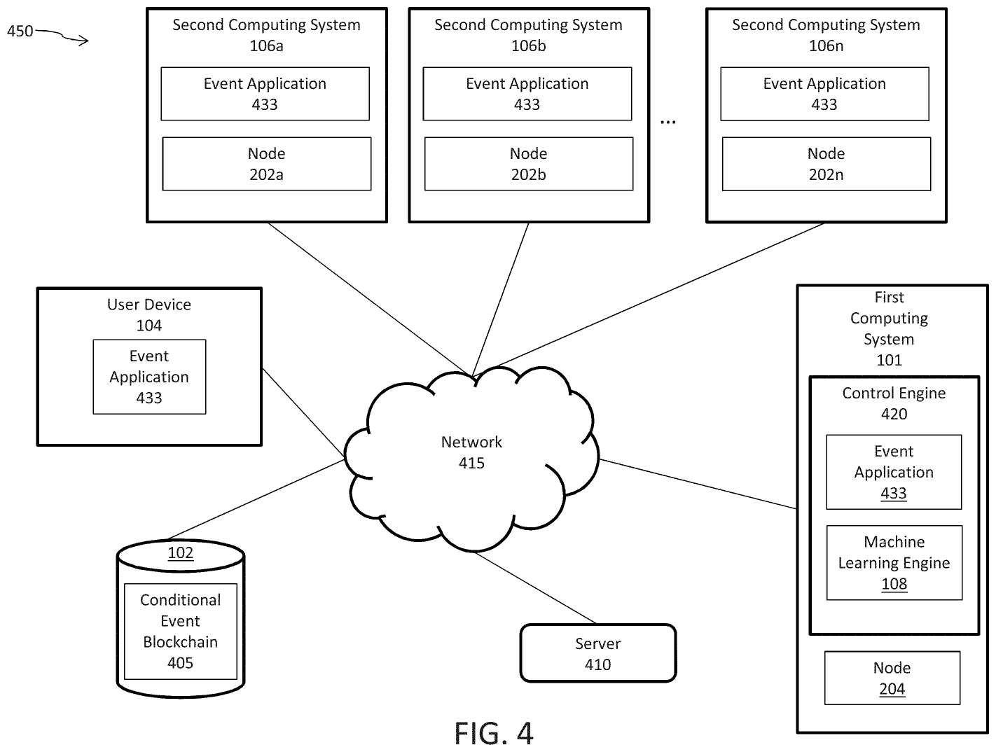

The data storage facility 102 can be configured to store a copy of a cryptographically verifiable ledger including a sequence of blocks. Each block can include information received from the first computing system 101, the user device 104, and/or the independently operated computing systems 106a-d. The cryptographically verifiable ledger is described in further detail with respect to FIGS. 2 and 4. The data received from the first computing system 101, the user device 104, and the independently operated computing systems 106a-d can be associated with a conditional event. The first computing system 101 or the independently operated second computing systems 106a-d can generate an executable logic data structure associated with the conditional even to be satisfied. Each of the first computing system 101 and/or the independently operated second computing systems 106a-d can execute the logic data structure, modify the logic data structure, void the logic data structure, and/or create a new logic data structure, based on data received from the first computing system 101, the user device 104, and/or the independently operated computing systems 106a-d.

The machine learning engine 108 can predict outcome data associated with the conditional event based on the data received from the first computing system 101, the user device 104, and/or the independently operated computing systems 106a-d. Each of the first computing system 101 or independently operated second computing systems 106a-d can execute the logic data structure, modify the logic data structure, void the logic data structure, and/or create a new logic data structure, based on the predicted outcome data. The machine learning engine 108 can utilize one or more machine learning algorithms. The machine learning algorithm(s) can include, for example, supervised learning algorithms, unsupervised learning algorithm, artificial neural network algorithms, association rule learning algorithms, hierarchical clustering algorithms, cluster analysis algorithms, outlier detection algorithms, semi-supervised learning algorithms, reinforcement learning algorithms and/or deep learning algorithms Examples of supervised learning algorithms can include, for example, AODE; Artificial neural network, such as Backpropagation, Autoencoders, Hopfield networks, Boltzmann machines, Restricted Boltzmann Machines, and/or Spiking neural networks; Bayesian statistics, such as Bayesian network and/or Bayesian knowledge base; Case-based reasoning; Gaussian process regression; Gene expression programming; Group method of data handling (GMDH); Inductive logic programming; Instance-based learning; Lazy learning; Learning Automata; Learning Vector Quantization; Logistic Model Tree; Minimum message length (decision trees, decision graphs, etc.), such as Nearest Neighbor algorithms and/or Analogical modeling; Probably approximately correct learning (PAC) learning; Ripple down rules, a knowledge acquisition methodology; Symbolic machine learning algorithms; Support vector machines; Random Forests; Ensembles of classifiers, such as Bootstrap aggregating (bagging) and/or Boosting (meta-algorithm); Ordinal classification; Information fuzzy networks (IFN); Conditional Random Field; ANOVA; Linear classifiers, such as Fisher's linear discriminant, Linear regression, Logistic regression, Multinomial logistic regression, Naive Bayes classifier, Perceptron, and/or Support vector machines; Quadratic classifiers; k-nearest neighbor; Boosting; Decision trees, such as C4.5, Random forests, ID3, CART, SLIQ, and/or SPRINT; Bayesian networks, such as Naive Bayes; and/or Hidden Markov models. Examples of unsupervised learning algorithms can include Expectation-maximization algorithm; Vector Quantization; Generative topographic map; and/or Information bottleneck method. Examples of artificial neural network can include Self-organizing maps. Examples of association rule learning algorithms can include Apriori algorithm; Eclat algorithm; and/or FP-growth algorithm. Examples of hierarchical clustering can include Single-linkage clustering and/or Conceptual clustering. Examples of cluster analysis can include K-means algorithm; Fuzzy clustering; DBSCAN; and/or OPTICS algorithm. Examples of outlier detection can include Local Outlier Factors. Examples of semi-supervised learning algorithms can include Generative models; Low-density separation; Graph-based methods; and/or Co-training. Examples of reinforcement learning algorithms can include Temporal difference learning; Q-learning; Learning Automata; and/or SARSA. Examples of deep learning algorithms can include Deep belief networks; Deep Boltzmann machines; Deep Convolutional neural networks; Deep Recurrent neural networks; and/or Hierarchical temporal memory. The machine learning algorithm(s) can be trained using a corpus of training data, such as the data from the independently operated second computing systems 106a-d described herein.

As a non-limiting example, the conditional event can be associated with a monetary loan requested for by the user. The independently operated second computing systems 106a-d can include a credit bureau system 106a, a user's employer's system 106b, a payroll processor's system 106c, and a lending financial institution system 106d. The first computing system 101 can be embodied as an intermediary party's system. The intermediary party's system can provide purchase history and intermediary party credit payment history data associated with the user requesting the loan to the data storage facility 102. The credit bureau system 106a can provide credit history data and credit scoring data to the data storage facility 102. The user's employer's system 106b can provide months on the job, weekly/monthly payroll, payroll variability, direct deposit history, and direct deposit allocation to deposited backed financial purchases data to the data storage facility. The payroll processor's system 106c can provide months on the job, weekly/monthly payroll, and payroll variability data to the data storage facility 102. The lending financial institution 106d can provide current deposit backed financing lending request data and deposit backed financing approval history data to the data storage facility 102. The user device 104 can provide account balance, user deposit history, purchase vault history, savings vault balance, customer expense budget, deposit backed financing lending requests, deposits backed financing payment history, and withdrawal history data to the data storage facility 102.

Based on the request for the loan, the first computing system 101 and/or the independently operated second computing systems 106a-d can generate an executable logic data structure based on the data in the data storage facility 102 and the request. The logic data structure can be included in a smart contract, which can also include the constraints (e.g., terms), amount of loan, and a time period by when the loan must be repaid. The machine learning engine 108 can predictively predict outcome data associated with the smart contract. For example, based on a recent purchase history and recent payroll data, the machine learning engine 108 can determine the likelihood of the user to repay the loan. Based on the predicted outcome data, the first computing system 101 and/or the independently operated second computing systems 106a-d can execute, modify, void, or generate logic data structures in a new smart contract for the loan. For example, a lending financial institution may increase the interest rate of the loan or a time period it must be paid back based on the predicted data.

FIG. 2 is a block diagram of an ether blockchain consortium architecture 200 in accordance with an exemplary embodiment. As described above, the data storage facility 102 can include a copy of a cryptographically verifiable ledger. Each of the first computing system (e.g., first computing system 101) and the independently operated second computing systems (e.g., independently operated second computing systems 106a-d) can include a blockchain node. For example, the first computing system can include a node 204 and the independently operated second computing systems 106a-d can include node 202a-d, respectively. Each of the nodes 202a-d and 204 can include a complete or partial copy of the cryptographically verifiable ledger.

The cryptographically verifiable ledger can include a sequence of blocks. Each block can include data streamed by the first computing system, the independently operated second computing system, received by the data storage facility 102 from the user device and/or machine-learning engine 108, and a hash value to the previously generated block. Each of the nodes 202a-d, and 204 can generate new blocks in the cryptographically verifiable ledger when a new event occurs or new data is received.

The cryptographically verifiable ledger can store information associated with a conditional event requested by a user including the logic data structure. As a non-limiting example, the first computing system can be embodied as an intermediary party's system. The intermediary party's node 204 can generate blocks including data such as purchase history and intermediary party credit payment history data associated with the user requesting a loan. The credit bureau system node 202a can generate blocks including data such as credit history data and credit scoring. The user's employer's system node 202b can generate blocks including data such as months on the job, weekly/monthly payroll, payroll variability, direct deposit history, and direct deposit allocation to deposited backed financial purchases data to the data storage facility. The payroll processor's system 202c can generate blocks including data such as months on the job, weekly/monthly payroll, payroll variability. The lending financial institution 202d can generate blocks including data such as current deposit backed financing lending request and deposit backed financing approval history.

As a non-limiting example, the user can transmit a request for a monetary loan to the first computing system. The first computing system and/or one of the independently operated second computing systems can generate a smart contract for the loan associated with the user. The smart contract can include an executable logic data structure. The nodes 202a-d or 204 can generate a block in the cryptographically verifiable ledger to store the smart contract. The smart contract can include the amount of the loan, constraints, and conditions of the loan. The constraints can include various parties (i.e., first or second computing systems) that must verify the loan. For example, the lending financial institution node 202d can generate a smart contract including an executable logic data structure to facilitate lending an amount of money to a user, to be paid back by a specified date upon the credit bureau verifying the credit score of the user and the user's employer's verifying the payroll data of the user. In response to generating a new block including the smart contract, the lending financial institution can transmit an alert to the credit bureau's node 202a and the user's employer's node 202b of the creation of the new block in the cryptographically verifiable ledger including the smart contract.

In response to receiving the alert, the credit bureau's node 202a can verify the credit score data. The credit bureau node 202a can generate a new block including the credit score data and verification of the credit score data in view of the smart contract. In response to receiving the alert, the user's employer's node 202b can verify the payroll data and generate a new block in the cryptographically verifiable ledger including the payroll data and verification of the payroll data in view of the smart contract. In response to the generation of the new blocks by the credit bureau node 202a and the user's employer's node 202b, the smart contract can be executed. In one embodiment, in response to a failure of verification of the respective data by either of the credit bureau system or the user's employer's system, each or either of the credit bureau node 202a and the user's employer's node 202b can generate a block in the cryptographically verifiable ledger including data indicating a failure to verify the respective data. In response to a generation of the new blocks indicating the failure to verify the respective data, the lending financial institution system can receive an alert. The lending financial institution node 202 can modify the smart contract, void the smart contract, and/or generate a new smart contract, in response to receiving the alert. The lending financial institution node 202 can generate a new block including data associated with the modification of the smart contract, voiding the smart contract, and/or generating a new smart contract.

In one embodiment, the machine learning engine 108 can generate predictive data based on data in the blocks of the cryptographically verifiable ledger associated with the conditional event and/or logic data structure. Continuing with the non-limiting example, based on blocks in the cryptographically verifiable ledger including data associated with recent purchase history and recent payroll data, the machine learning engine 108 can determine the likelihood of the user to repay the loan. The first computing system node 204 can generate a new block indicating the predictive data in the cryptographically verifiable ledger. Based on the predictive data, the first computing system node 204 and/or the independently operated second computing system nodes 202a-d can generate a new block in the cryptographically verifiable ledger indicating execution the logic data structure in the smart contract, modifying the logic data structure in the smart contract, voiding the logic data structure in the smart contract, or generate an executable logic data structure in a new smart contract for the loan. For example, a lending financial institution may increase the interest rate of the loan or a time period it must be paid back based on the predicted data. The lending financial institution node 202d can generate a new block indicating the new/modified smart contract including the increased interest rate or adjusted time period the loan must be paid back.

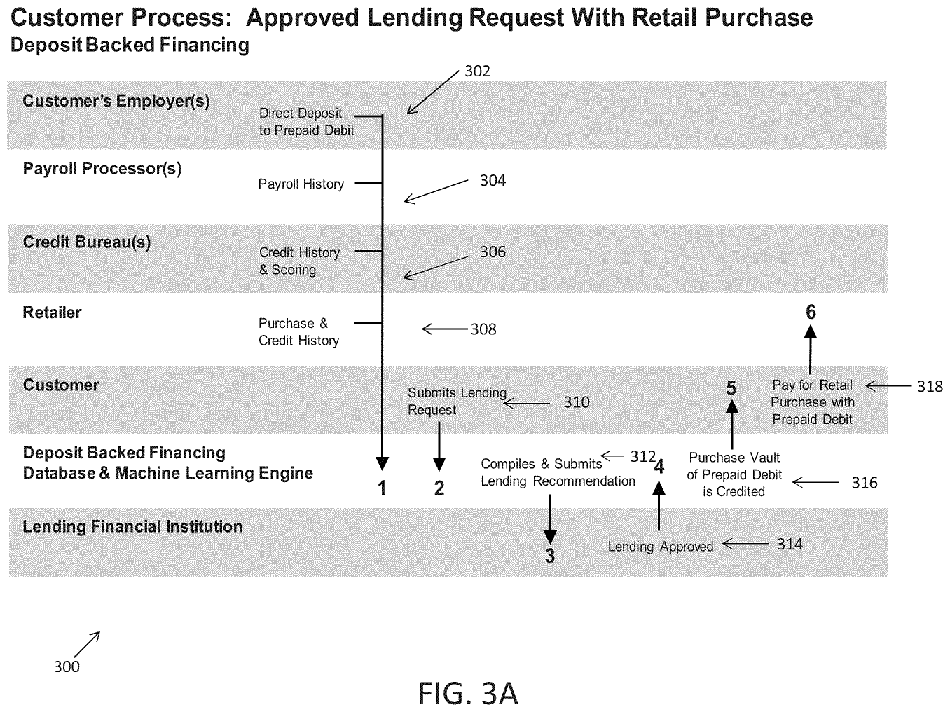

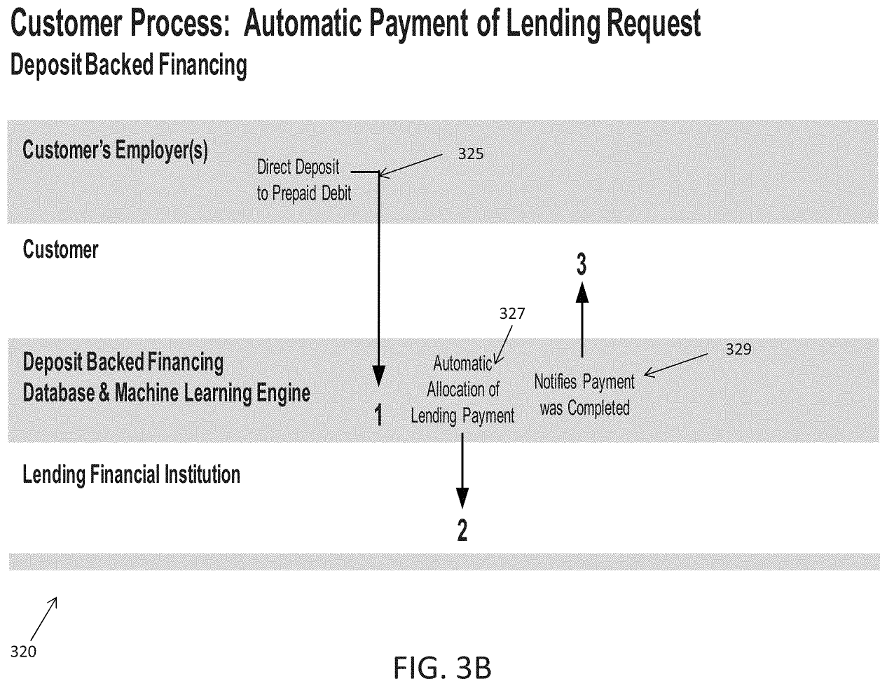

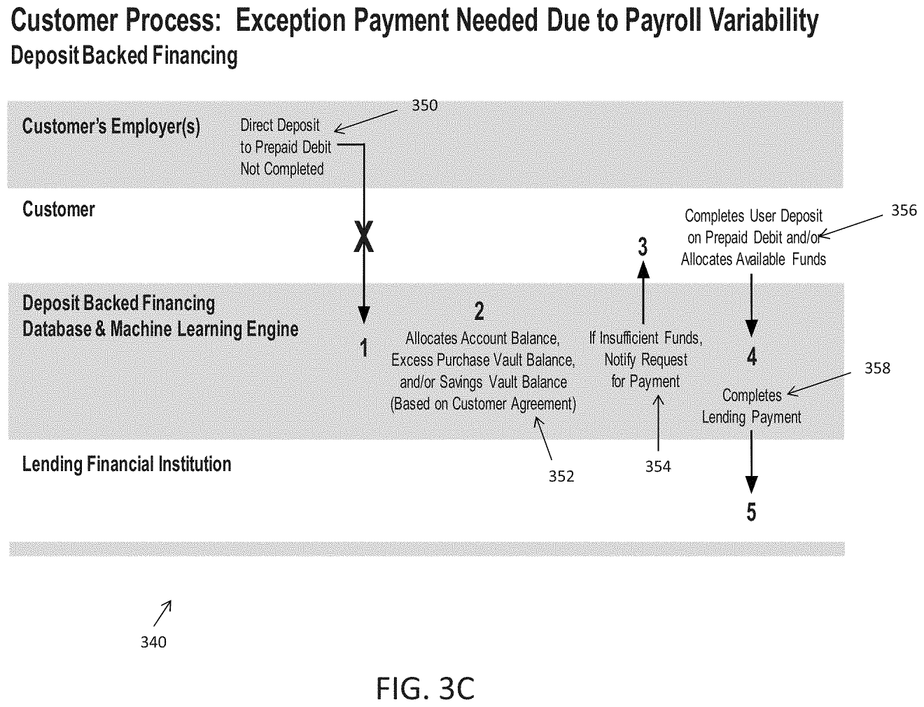

FIGS. 3A-C depict exemplary processes in accordance with an exemplary embodiment. With reference to FIG. 3A, as a non-limiting example, an embodiment of the system 100 can be implemented to process conditional requests such as an approved lending request for a retail purchase. The process 300 can be implemented using the first computing system (e.g., first computing system 101 as shown in FIG. 1), the data storage facility (e.g., data storage facility 102 as shown in FIG. 1-2), and the independently operated second computing systems (e.g., independently operated second computing systems 102a-d as shown in FIG. 1). In operation 302, a user's employer's system can direct deposit all or some of a paycheck to a prepaid debit card. In operation 304, the payroll processor(s) can generate a payroll history of the user. In operation 306, the credit bureau can generate a credit history and credit scoring data. In operation 308, an intermediary party can generate purchase history and credit history data. In operation 310, a user can transmit a request for a loan for a retail purchase. In operation 312, the machine learning engine (e.g., machine learning engine 108 as shown in FIGS. 1-2) can generate predictive data, compile and transmit a recommendation on the lending request. In operation 314, a lending financial institution can approve the loan based on the recommendation on the lending request. In operation 316, the machine learning engine can debit a prepaid debit card with the loan amount based on the approval. In operation 318, the prepaid debit card can be used to purchase an item at the intermediary party.

With reference to FIG. 3B, as a non-limiting example, an embodiment of the system 100 can implement a process 320. As one non-limiting example, the process can be associated with automatic repayment of a lending request. The process 320 can be implemented using the first computing system (e.g., first computing system 101 as shown in FIG. 1), the data storage facility (e.g., data storage facility 102 as shown in FIG. 1-2), and the independently operated second computing systems (e.g., independently operated second computing systems 102a-d as shown in FIG. 1). In operation 325, a user's employers can transmit a direct deposit of some or all of a paycheck to a prepaid debit card. In operation 327, the machine learning engine (e.g., machine learning engine 108 as shown in FIG. 1-2) can automatically allocate a portion or all of the amount on the prepaid debit card for the repayment of the lending request. In operation 329, the machine learning engine can notify the user of repayment of the lending request.

With reference to FIG. 3C, as a non-limiting example, an embodiment of the system 100 can implement a process 340. As a non-limiting example, the process 340 can be associated with exception payments needed due to payroll variability. The process 340 can be implemented using the first computing system (e.g., first computing system 101 as shown in FIG. 1), the data storage facility (e.g., data storage facility 102 as shown in FIG. 1-2), and the independently operated second computing systems (e.g., independently operated second computing systems 102a-d as shown in FIG. 1). In operation 350, a user's employers may not complete a transfer of a direct deposit of some or all of a paycheck to a prepaid debit card. In operation 352, the machine learning engine (e.g., machine learning engine 108 as shown in FIG. 1-2) can automatically allocate a portion of an amount in a user's bank account, vault balance, and/or savings vault balance based on a request from the user, for repayment of the lending request. In operation 354, in the event, there are insufficient funds in the bank account, vault balance, and/or savings vault balance, the machine learning engine can notify the user for a request for repayment of the lending request. In operation 356, the user can deposit a specified amount onto a prepaid debit card. In operation 358, the machine learning engine can complete the repayment of the lending request using the prepaid debit card. The vault balance and/or the savings vault balance can be a monetary amount for a user which is associated with the intermediary party.

FIG. 4 illustrates an exemplary network environment 450 for implementing an embodiment of the system 100 in accordance with an exemplary embodiment. The network environment 450 can include one or more data storage facilities 102, one or more first computing systems 101, one or more independently operated second computing systems 106a-n, and one or more user devices 104. The first computing system 101 can be in communication with the data storage facilities 102, the independently operated second computing systems 106a-n, and the user devices 104, via a communications network 415. The user devices 104 can be associated with users. The independently operated second computing systems 106a-n and the user devices 104 can execute an instance of an event application 433. The event application 433 can be an executable application configured to generate, modify, and execute logic data structures associated with conditional events stored in blocks of a cryptographically verifiable ledger.

The first computing system 101 can execute at least one instance of a control engine 320. The control engine 320 can be an executable application executed on the first computing system 101. The control engine 320 can execute processes as described herein. The control engine 320 can include an instance of the event application 433 and the machine learning engine 108. The machine learning engine 108 can predict outcome data associated with the logic structures of conditional events as described herein.

In an example embodiment, one or more portions of the communications network 415 can be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, another type of network, or a combination of two or more such networks.

The server 410 or first computing system 101 includes one or more computers or processors configured to communicate with the independently operated second computing systems 106a-n, and the user devices 104. The data storage facilities 102 can store information/data, as described herein. For example, the data storage facilities 102 can include a conditional event blockchain 405. The conditional event blockchain 405 can embody the cryptographically verifiable ledger as described herein. A blockchain, as used herein, may generally refer to a distributed database that maintains a growing and ordered list or chain of records/blocks in which each block contains a hash of some or all previous records/blocks in the chain to secure the record from tampering and unauthorized revision. A hash generally refers to a derivation of original data using an algorithm such as Secure Hashing Algorithm (SHA) -1, SHA-2, or SHA-3. SHA-1 is a 160 bit hash, SHA-2 and SHA-3 are family of hashes which can be a variety of different bit lengths. In some embodiments, the hash in a block of a blockchain may include a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may include one or more of a data hash of the previous block, a timestamp, a cryptographic nonce, a proof standard, and a data descriptor to support the security and/or incentive features of the system. As an example, the blockchain storage system can store digital licenses, invoices, receipts, or rights of ownership associated with conditional events and the first computing system 101 or one or more of the independently operated second computing systems 106a-n can use the blocks of the blockchain to authorize the execution of a conditional event. The data storage facilities 102 and the first computing system 101 can be located at one or more geographically distributed locations from each other. Alternatively, the data storage facilities 102 can be included within the first computing system 101.

The first computing system 101 and the independently operated second computing systems 106a-n can include one or more nodes 204 and 202a-n, respectively. Each of the one or more nodes 204 and 202a-n can store a copy of the conditional event blockchain 405. The one or more nodes 204 and 202a-n can be configured to update the blocks in the conditional event blockchain 405 based on executed events using the event application 433. The nodes 204 and 202a-n can verify that an event has occurred which spawned the creation of the new block in the conditional event blockchain 405.

In one embodiment, a user device 104 can transmit a request to the first computing system 101 for a conditional event, using the event application 433. The control engine 420 can receive the request using the event application 433. The event application 433 can instruct the node 204 to generate a first block in the conditional event blockchain 405 indicating the request for the conditional event. The block can include information associated with the conditional event and the user associated with the user device 106. The event application 433 can further generate a second block including an executable logic data structure for the conditional event. The new block can include a hash value associated with the previous block and constraints associated with the conditional event. The event application 433 can generate and transmit an alert to one or more of the independently operated second computing systems 106a-n of the creation of the first and second blocks.

The independently operated second computing systems 106a-n can verify the first and second blocks using the events application 433. One or more of the independently operated second computing systems 106a-n can generate subsequent blocks in the conditional event blockchain 405 associated with the logical structure for the conditional event or the user requesting the conditional event. The machine learning engine 108 of the first computing system 101 can track each block being generated in the conditional event blockchain 405. The machine learning engine 108 can predict outcome data associated with the logic data structure of the conditional event or the user requesting the conditional event. The machine learning engine 108 can generate a user specific value associated with the user requesting the conditional event based on the blocks in the conditional event blockchain 405 and/or the predicted outcome data. The events application 433 of the first computing system 101 can generate a new block to include the user specific value. The events application 433 of the first computing system 101 can generate and transmit an alert to one or more of the independently operated second computing systems 106a-n indicating the creation of the new block including the user specific value. The first computing system 101 and/or the independently operated second computing systems 106a-n can trigger an action associated with the logic data structure based on the user specific value. The first computing system 101 and/or the independently operated second computing systems 106a-n can generate additional block(s) in the conditional event blockchain 405 including the triggered action.

In one embodiment, the independently operated second computing systems 106a-n and the first computing system 101 can predict the user specific value using a predictive analysis based on information stored in the blocks of the conditional event blockchain 405. The user specific value can change as new blocks in the conditional event blockchain 405 are generated.

The actions can include executing the logic data structure, modification of the logic data structure, voiding the logic data structure, or creating a new logic data structure. The constraints of the logical structure can include the constraints include a verification of the information in the additional blocks including the user specific value by the one or more of the plurality of second computing systems or the first computing system.

In one embodiment, each of the independently operated second computing systems can be configured to store, receive, and transmit with information of a different type. The conditional events can include one or more conditions. The conditions can include a requirement of one or more responsive events in response to the conditional events and a date and time of execution of the responsive events. The user specific value can be associated with the likelihood of the user of the user device 106 executing the one or more response events.

In one embodiment, the first computing system 101 and/or the independently operated second computing systems 106a-n can generate new blocks in the conditional event blockchain 405 including information associated with the one or more response events. Constraints associated with the logical structure of the conditional event include a confirmation of the execution of the one or more responsive events by the one or more of independently operated second computing systems 106a-n or the first computing system 101.

As a non-limiting example, the networking environment 450 can be used to implement request for monetary loans and repayment of monetary loans. The first computing system 101 can be associated with an intermediary party. The conditional event can be a loan. The logical structure can be a smart contract for the loan. The responsive events can be repayments of the loan amount. The user specific value can be associated with a risk value of a user in connection with likelihood of repayment of the loan. The independently operated second computing systems 106a-n can be user's employers, payroll processor(s), lending financial institution(s), and credit bureau(s).

Continuing with the non-limiting example, a user can attempt to request for a monetary loan for purchasing a specific item at a retail store. The user can submit a request for the loan using the events application 433 executing on the user device 106. The user can transmit information associated with the request such as amount of loan, item to be purchased, and other information associated with the request. The control engine 420 of the first computing system 101 can receive the request and the events application 433 of the first computing system 101 can generate a smart contract for the loan. The events application 433 can generate a first block in the conditional event blockchain 405 including the request for the loan and a second block in the conditional event blockchain 405 including a smart contract for the loan and constraints associated with the smart contract. The constraints can include interest amount, time period for repayment of the loan, the item to be purchased from the loan amount and other constraints associated with the smart contract and loan.

The independently operated second computing systems 106a-n can generate subsequent blocks associated with the smart contract of the loan or the user. For example, the subsequent blocks can include, credit information associated with the user, payroll information of the user, recent purchase history of the user, and/or employment history of the user. The machine learning engine 108 can predict outcome data associated with the user and loan based on the blocks in the conditional event blockchain 405. The events can be associated with expected credit information associated with the user, expected payroll information of the user, expected purchases of the user, and/or expected employment volatility of the user. The machine learning engine 108 can generate a user specific value (i.e., risk value) for the user's likelihood to repay the loan. The events application 433 of the first computing system 101 can generate a block including the user specific value. The fist computing system 101 and/or one or more of the second computing systems 106a-n can trigger an action associated with the smart contract based on the user specific value. The action can be to execute the smart contract, modify the smart contract, void the smart contract, and/or generate a new smart contract. The first computing system 101 and/or one or more of the second computing systems 106a-n can generate a new block in the conditional event blockchain 405 including the triggered action.

In response to executing a smart contract for the loan, the loan amount can be transferred to a payment device for a user. The user can use the payment device to purchase the item for which the loan was requested. The first computing system 101 can generate a new block in the conditional event blockchain 405 including information associated with the use of the payment device to purchase the item. The machine learning engine 108 can predict repayments of the loan in response to the use of the payment device.

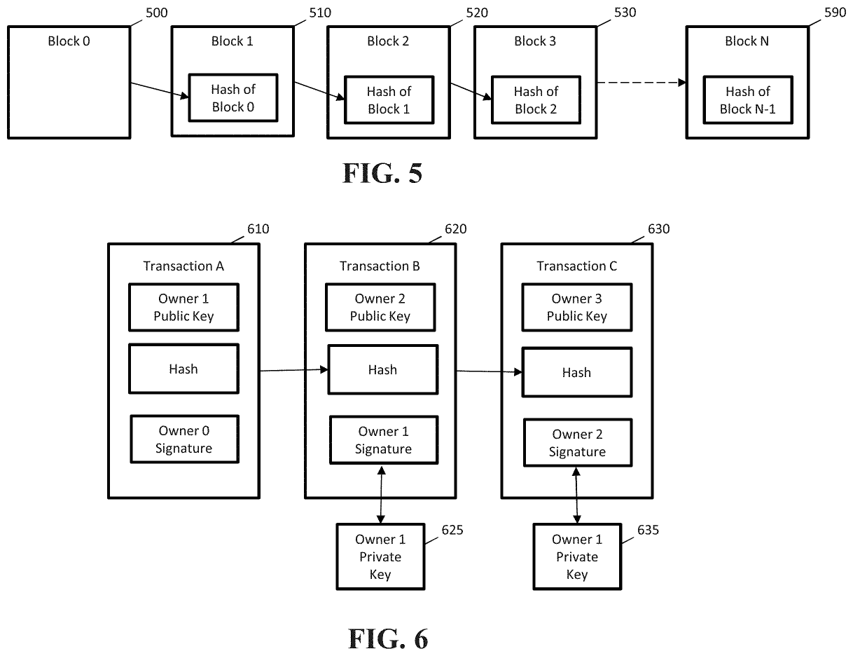

Now referring to FIG. 5, an illustration of a blockchain according to embodiments of the present disclosure is shown. As mentioned in above, with reference to FIG. 4, a blockchain includes a hash chain or a hash tree in which each block added in the chain contains a hash of the previous block. In FIG. 5, block 0 500 represents a genesis block of the chain and can be generated in response to initiation of a request for a conditional event. The block 0 500 can include information associated with the request for a conditional event and a hash key, and a timestamp. The information associated with the conditional event can include details associated with the conditional event, date of the request, information associated with the user requesting the conditional event. Block 1 510 can be generated in response to a logic data structure associated with the conditional event being generated. The block 1 510 can contain a hash of block 0 500. The block 1 510 can include information associated with the logical structure. Additional blocks can be generated as additional requests are received and each block that is generated can include a hash of a previous block. For example, block 2 520 can be generated in response to an action (execute, modify, void) associated with the logical structure and can contain a hash of block 1 510, block 3 530 can be generated in response to a yet another subsequent request and can contain a hash of block 2 520, and so forth. Continuing down the chain, block N contains a hash of block N-1. The block N can include information of the execution or failure to execute the logical structure. In some embodiments, the hash may include the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may include a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may include a plurality of transaction and/or activity records.

In some embodiments, the blocks generated by the central computing system can contain rules and data for authorizing different types of actions and/or parties who can take action as described herein. In some embodiments, transaction and block forming rules may be part of the software algorithm on each node. When a new block is being formed, any node on the system can use the prior records in the blockchain to verify whether the requested action is authorized. For example, a block may contain a public key associated with the user of a user device that purchased/acquired the design file that allows the user to show possession and/or transfer the digital license using a private key. In some embodiments, rules themselves may be stored in the blockchain such that the rules are also resistant to tampering once created and hashed into a block. In some embodiments, the blockchain system may further include incentive features for nodes that provide resources to form blocks for the chain. Nodes can compete to provide proof-of-work to form a new block, and the first successful node of a new block earns a reward.

Now referring to FIG. 6, an illustration of blockchain based transactions according to some embodiments is shown. In some embodiments, the blockchain illustrated in FIG. 6 includes a hash chain protected by private/public key encryption. Transaction A 610 represents a transaction recorded in a block of a blockchain showing that owner 1 (user). Transaction A 610 contains owner's 1 public key and owner 0's signature for the transaction and a hash of a previous block. When owner 1 (e.g., the user) transmits a request for a conditional event to owner 2 (e.g., first computing system), a block containing transaction B 620 is formed. The record of transaction B 620 includes the public key of owner 2 (e.g., first computing system), a hash of the previous block, and owner 1's signature for the transaction that is signed with the owner 1's private key 625 and verified using owner 1's public key in transaction A 610. If owner 2 (e.g., the first computing system) generates a logical structure to be executed between the first computing system and owner 3 (one or more of independently operated second computing systems), a block containing transaction C 630 is formed. The record of transaction C 630 includes the public key of owner 3 (one or more of independently operated second computing systems), a hash of the previous block, and owner 2's signature for the transaction that is signed by owner 2's private key 635 and verified using owner 2's public key from transaction B 620. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 6 are shown as an example only. In some embodiments, a blockchain record and/or the software algorithm may include any type of rules that regulate who and how the chain may be extended. In some embodiments, the rules in a blockchain may include clauses of a smart contract that is enforced by the peer-to-peer network.

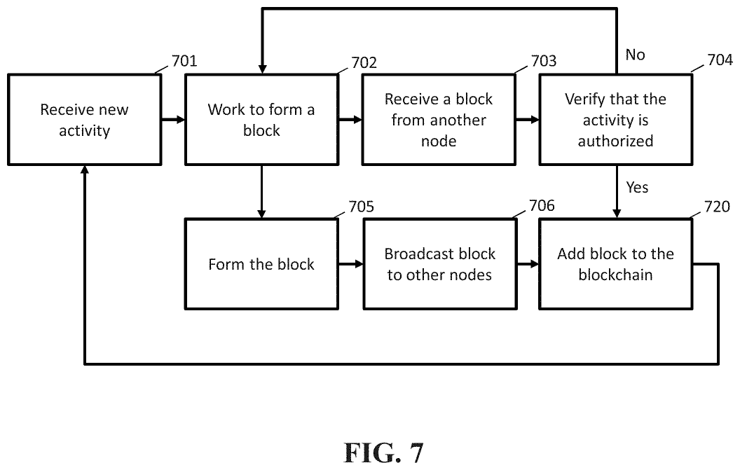

Now referring to FIG. 7, a flow diagram according to some embodiments is shown. In some embodiments, the steps shown in FIG. 7 may be performed by a computer system as described in FIG. 4, a server, a distributed server, a timestamp server, a blockchain node, and the like. In some embodiments, the steps in FIG. 7 may be performed by one or more of the nodes in a system using blockchain for record keeping.

In step 701, a node receives a new activity in response to a request for a conditional event. The new activity may include an update to the record being kept in the form of a blockchain. In some embodiments, for blockchain supported digital or physical record keeping, the new activity can correspond to the conditional event and logic structure associated with the conditional event. In some embodiments, the new activity may be broadcasted to a plurality of nodes on the network prior to step 701. In step 702, the node works to form a block to update the blockchain. In some embodiments, a block may include a plurality of activities or updates and a hash of one or more previous block in the blockchain. In some embodiments, the system may include consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 702, if the node successfully forms a block in step 705 prior to receiving a block from another node, the node broadcasts the block to other nodes over the network in step 706. In step 720, the node then adds the block to its copy of the blockchain. In the event that the node receives a block formed by another node in step 703 prior to being able to form the block, the node works to verify that the activity (e.g., authentication of transfer) recorded in the received block is authorized in step 704. In some embodiments, the node may further check the new block against system consensus rules for blocks and activities to verify whether the block is properly formed. If the new block is not authorized, the node may reject the block update and return to step 702 to continue to work to form the block. If the new block is verified by the node, the node may express its approval by adding the received block to its copy of the blockchain in step 720. After a block is added, the node then returns to step 701 to form the next block using the newly extended blockchain for the hash in the new block.

In some embodiments, in the event one or more blocks having the same block number is received after step 720, the node may verify the later arriving blocks and temporarily store these blocks if they pass verification. When a subsequent block is received from another node, the node may then use the subsequent block to determine which of the received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 701.

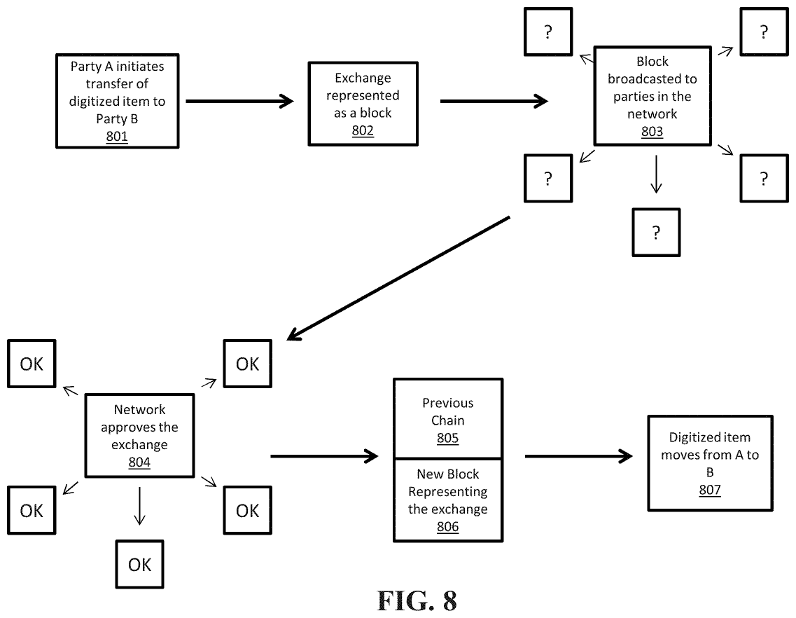

Now referring to FIG. 8, a process diagram for a blockchain update according to some embodiments is shown. In step 801, party A (an initial user such as a third party computing system) initiates the requesting a conditional event from to party B (the retail store). In some embodiments, Party A may be authenticated by signing the transaction with a private key that may be verified with a public key in the previous transaction associated with the conditional event are to be completed. In step 802, the authentication initiated in step 801 is represented as a block. In some embodiments, the transaction may be compared with transaction records in the longest chain in the distributed system to verify part A's authentication. In some embodiments, a plurality of nodes in the network may compete to form the block containing the authentication record. In some embodiments, nodes may be required to satisfy proof-of-work by solving a difficult mathematical problem to form the block. In some embodiments, other methods of proof such as proof-of-stake, proof-of-space, etc. may be used in the system. In step 803, the block is broadcasted to parties in the network. In step 804, nodes in the network authenticate party A by examining the block that contains the party A's authentication. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the object to be transferred). In some embodiments, a block may be approved with consensus of the nodes in the network. After a block is approved, the new block 806 representing the authentication is added to the existing chain 805 including blocks that chronologically precede the new block 806. The new block 806 may contain the transaction(s) and a hash of one or more blocks in the existing chain 805. In some embodiments, each node may then update their copy of the blockchain with the new block and continue to work on extending the chain with additional transactions. In step 807, when the chain is updated with the new block, the conditional event can be initiated between party A and party B.

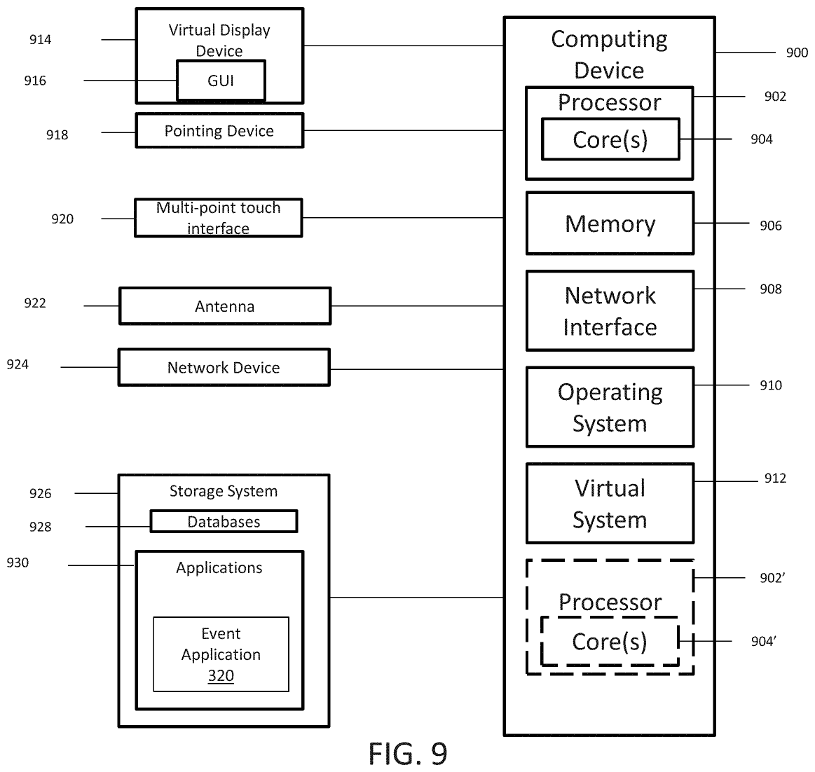

FIG. 9 is a block diagram of an example computing device for implementing exemplary embodiments of the present disclosure. The computing device 900 may be, but is not limited to, a smartphone, laptop, tablet, desktop computer, server or network appliance. The computing device 900 can be embodied as part of the first computing system, independently operated second computing systems, or user device. The computing device 900 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives, one or more solid state disks), and the like. For example, memory 906 included in the computing device 900 may store computer-readable and computer-executable instructions or software (e.g., applications 930 such as the control engine 420, contracts application 433, and machine learning engine 108) for implementing exemplary operations of the computing device 900. The computing device 900 also includes configurable and/or programmable processor 902 and associated core(s) 904, and optionally, one or more additional configurable and/or programmable processor(s) 902′ and associated core(s) 904′ (for example, in the case of computer systems having multiple processors/cores), for executing computer-readable and computer-executable instructions or software stored in the memory 906 and other programs for implementing exemplary embodiments of the present disclosure. Processor 902 and processor(s) 902′ may each be a single core processor or multiple core (904 and 904′) processor. Either or both of processor 902 and processor(s) 902′ may be configured to execute one or more of the instructions described in connection with computing device 900.

Virtualization may be employed in the computing device 900 so that infrastructure and resources in the computing device 900 may be shared dynamically. A virtual machine 912 may be provided to handle a process running on multiple processors so that the process appears to be using only one computing resource rather than multiple computing resources. Multiple virtual machines may also be used with one processor.

Memory 906 may include a computer system memory or random access memory, such as DRAM, SRAM, EDO RAM, and the like. Memory 906 may include other types of memory as well, or combinations thereof.

A user may interact with the computing device 900 through a visual display device 914, such as a computer monitor, which may display one or more graphical user interfaces 916, multi touch interface 920, a pointing device 918, an image capturing device 934 and a scanner 932.

The computing device 900 may also include one or more computer storage devices 926, such as a hard-drive, CD-ROM, or other computer-readable media, for storing data and computer-readable instructions and/or software that implement exemplary embodiments of the present disclosure (e.g., applications). For example, exemplary storage device 926 can include one or more databases 928 for storing the conditional event blockchain. The databases 928 may be updated manually or automatically at any suitable time to add, delete, and/or update one or more data items in the databases.

The computing device 900 can include a network interface 908 configured to interface via one or more network devices 924 with one or more networks, for example, Local Area Network (LAN), Wide Area Network (WAN) or the Internet through a variety of connections including, but not limited to, standard telephone lines, LAN or WAN links (for example, 802.11, T1, T3, 56kb, X.25), broadband connections (for example, ISDN, Frame Relay, ATM), wireless connections, controller area network (CAN), or some combination of any or all of the above. In exemplary embodiments, the computing system can include one or more antennas 922 to facilitate wireless communication (e.g., via the network interface) between the computing device 900 and a network and/or between the computing device 900 and other computing devices. The network interface 908 may include a built-in network adapter, network interface card, PCMCIA network card, card bus network adapter, wireless network adapter, USB network adapter, modem or any other device suitable for interfacing the computing device 900 to any type of network capable of communication and performing the operations described herein.

The computing device 900 may run any operating system 910, such as versions of the Microsoft® Windows® operating systems, different releases of the Unix and Linux operating systems, versions of the MacOS® for Macintosh computers, embedded operating systems, real-time operating systems, open source operating systems, proprietary operating systems, or any other operating system capable of running on the computing device 900 and performing the operations described herein. In exemplary embodiments, the operating system 910 may be run in native mode or emulated mode. In an exemplary embodiment, the operating system 910 may be run on one or more cloud machine instances.

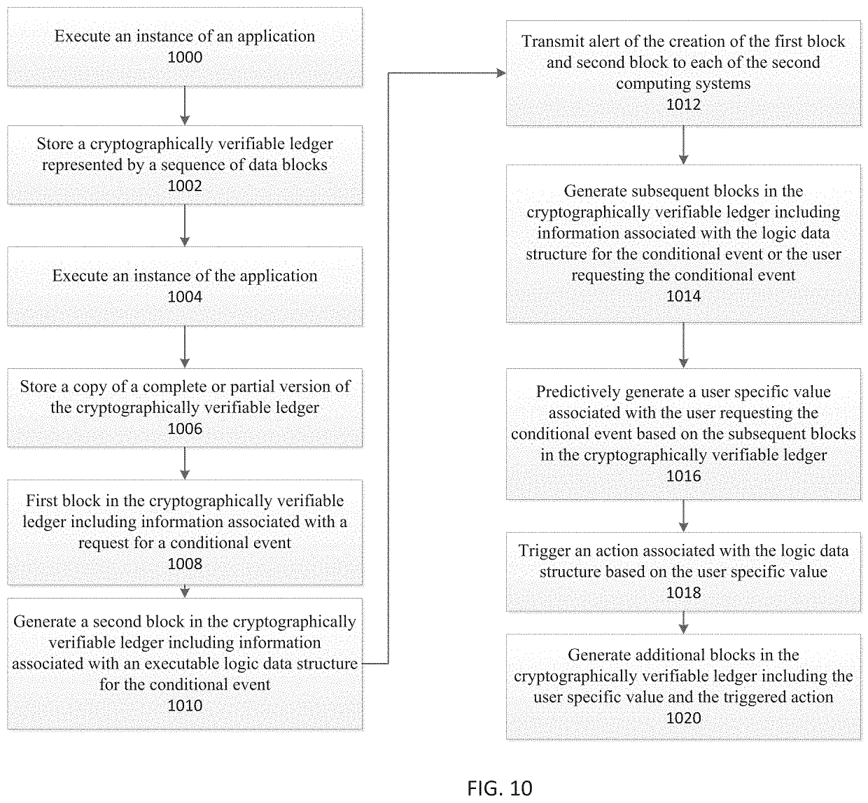

FIG. 10 is a flowchart illustrating a process of the predictive outcome generation system using blockchain controls. In operation 1000, a first computing system (e.g., first computing system 101 as shown in FIGS. 1 and 4) can execute an instance of an application (e.g., contracts application 433 as shown in FIG. 4). In operation 1002, the first computing system can store a cryptographically verifiable ledger (e.g., conditional event blockchain 102 as shown in FIGS. 1-2, and 4) represented by a sequence of data blocks. Each data block can contain one or more transaction records and each subsequent data block containing a hash value associated with a previous data block to link the data blocks in the sequence. In operation 1004, independently operated second computing systems (e.g., second computing systems 106a-n as shown in FIGS. 1 and 4) can execute an instance of the application. In operation 1006, each of the independently operated second computing systems can store a copy of a complete or partial version of the cryptographically verifiable ledger.

In operation 1008, the first computing system can generate a first block in the cryptographically verifiable ledger including information associated with a request for a conditional event. The first block includes identification information associated with a user requesting the conditional event, and a date of the request to be satisfied. In operation 1010, the first computing system can generate a second block in the cryptographically verifiable ledger including information associated with an executable logic data structure for the conditional event. The second block can include a hash value associated with the first block and constraints associated with the logic data structure for the conditional event. In operation 1012, the first computing system can transmit alert of the creation of the first block and second block to each of the second computing systems.

In operation 1014, the application executed on the one or more independently operated second computing systems can generate subsequent blocks in the cryptographically verifiable ledger including information associated with the logic data structure for the conditional event or the user requesting the conditional event. In operation 1016, the application executed on the one or more independently operated second computing systems or the first computing system can predictively generate a user specific value associated with the user requesting the conditional event based on the subsequent blocks in the cryptographically verifiable ledger. In operation 1018, the application executed on the one or more independently operated second computing systems or the first computing system can trigger an action associated with the logic data structure based on the user specific value. In operation 1020, the application executed on the one or more independently operated second computing systems or the first computing system can generate additional blocks in the cryptographically verifiable ledger including the user specific value and the triggered action.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a multiple system elements, device components or method steps, those elements, components or steps may be replaced with a single element, component or step. Likewise, a single element, component or step may be replaced with multiple elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the present disclosure. Further still, other aspects, functions and advantages are also within the scope of the present disclosure.

One or more of the exemplary embodiments, include one or more localized Internet of Things (IoT) devices and controllers. As a result, in an exemplary embodiment, the localized IoT devices and controllers can perform most, if not all, of the computational load and associated monitoring and then later asynchronous uploading of summary data can be performed by a designated one of the IoT devices to a remote server. In this manner, the computational effort of the overall system may be reduced significantly. For example, whenever a localized monitoring allows remote transmission, secondary utilization of controllers keeps securing data for other IoT devices and permits periodic asynchronous uploading of the summary data to the remote server. In addition, in an exemplary embodiment, the periodic asynchronous uploading of summary data may include a key kernel index summary of the data as created under nominal conditions. In an exemplary embodiment, the kernel encodes relatively recently acquired intermittent data (“KRI”). As a result, in an exemplary embodiment, KRI is a continuously utilized near term source of data, but KRI may be discarded depending upon the degree to which such KRI has any value based on local processing and evaluation of such KRI. In an exemplary embodiment, KRI may not even be utilized in any form if it is determined that KRI is transient and may be considered as signal noise. Furthermore, in an exemplary embodiment, the kernel rejects generic data (“KRG”) by filtering incoming raw data using a stochastic filter that provides a predictive model of one or more future states of the system and can thereby filter out data that is not consistent with the modeled future states which may, for example, reflect generic background data. In an exemplary embodiment, KRG incrementally sequences all future undefined cached kernels of data in order to filter out data that may reflect generic background data. In an exemplary embodiment, KRG incrementally sequences all future undefined cached kernels having encoded asynchronous data in order to filter out data that may reflect generic background data.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

1. A predictive outcome generation system, the system comprising:
a first computing system configured to execute an instance of an application and store a cryptographically verifiable ledger represented by a sequence of data blocks, each data block containing one or more transaction records and each subsequent data block containing a hash value associated with a previous data block to link the data blocks in the sequence;
a plurality of independently operated second computing systems, each second computing system in communication with the first computing system and configured to execute an instance of the application and store a copy of a complete or partial version of the cryptographically verifiable ledger;
wherein the first computing system is configured to:
generate a first block in the cryptographically verifiable ledger including information associated with a request for a conditional event, wherein the first block includes identification information associated with a user requesting the conditional event, and a date of the request to be satisfied;
generate a second block in the cryptographically verifiable ledger including information associated with a logic data structure for the conditional event, the second block including a hash value associated with the first block and constraints associated with the logic data structure for the conditional event;
transmit alert of the creation of the first block and second block to each of the plurality of second computing systems;
wherein one or more of the second computing systems are configured to:
generate, via the application, subsequent blocks in the cryptographically verifiable ledger including information associated with the logic data structure for the conditional event or the user requesting the conditional event;
wherein the one or more of the plurality of second computing systems or the first computing system is configured to:
predict, via the application, a user specific value associated with the user requesting the conditional event based on the subsequent blocks in the cryptographically verifiable ledger;
trigger an action associated with the logic data structure based on the user specific value;
generate additional blocks in the cryptographically verifiable ledger including the user specific value and the triggered action.

2. The system of claim 1, wherein each of the independently operated second computing systems is configured to store, receive, and transmit information of a different type.

3. The system of claim 1, wherein conditions of the conditional event include a requirement of one or more responsive events in response to the conditional events and a date and time of execution of the responsive events.

4. The system of claim 3, wherein the user specific value is associated with a likelihood of the user executing the one or more responsive events.

5. The system of claim 1, wherein the action is one or more of: executing the logic data structure, modification of the logic data structure, voiding the logic data structure, or creating a new logic data structure.

6. The system of claim 5, wherein the constraints include a verification of the information in the additional blocks including the user specific value by the one or more of the plurality of second computing systems or the first computing system.

7. The system of claim 1, wherein the one or more of the independently operated second computing systems or first computing system are configured to:
generate new blocks in the cryptographically verifiable ledger including information associated with one or more responsive events.

8. The system of claim 7, wherein the constraints include a confirmation of the execution of the one or more responsive events by the one or more of the plurality of second computing systems or the first computing system.

9. The system of claim 1, wherein the one or more of the independently operated second computing systems and the first computing system are configured to predict the user specific value using a predictive analysis based on the information in the first block, second block and the subsequent blocks.

10. The system of claim 9, wherein the one or more of the independently operated second computing systems and the first computing system are configured to predict the user specific value each time each subsequent block is generated.

11. A predictive outcome generation method, the method comprising:
executing, via a first computing system, an instance of an application;
storing, via the first computing system, a cryptographically verifiable ledger represented by a sequence of data blocks, each data block containing one or more transaction records and each subsequent data block containing a hash value associated with a previous data block to link the data blocks in the sequence;
executing, via a plurality of independently operated second computing systems, each second computing system in communication with the first computing system an instance of the application;
storing, via each of the plurality of independently operated second computing systems, a copy of a complete or partial version of the cryptographically verifiable ledger;
generating, via the first computing system, a first block in the cryptographically verifiable ledger including information associated with a request for a conditional event, wherein the first block includes identification information associated with a user requesting the conditional event, and a date of the request to be satisfied;
generating, via the first computing system, a second block in the cryptographically verifiable ledger including information associated with a logic data structure for the conditional event, the second block including a hash value associated with the first block and constraints associated with the logic data structure for the conditional event;
transmitting, via the first computing system, alert of the creation of the first block and second block to each of the plurality of second computing systems;
generating, via the application executed on the one or more of the independently operated second computing systems, subsequent blocks in the cryptographically verifiable ledger including information associated with the logic data structure for the conditional event or the user requesting the conditional event;
predicting, via the application of the one or more of the plurality of second computing systems or the first computing system, a user specific value associated with the user requesting the conditional event based on the subsequent blocks in the cryptographically verifiable ledger;
triggering, via the application of the one or more of the plurality of second computing systems or the first computing system, an action associated with the logic data structure based on the user specific value;
generating, via the application of the one or more of the plurality of second computing systems or the first computing system, additional blocks in the cryptographically verifiable ledger including the user specific value and the triggered action.

12. The method of claim 11, wherein each of the one or more of second computing systems is configured to store, receive, and transmit information of a different type.

13. The method of claim 11, wherein conditions of the conditional event includes a requirement of one or more responsive events in response to the conditional events and a date and time of execution of the responsive events.

14. The method of claim 13, wherein the user specific value is associated with a likelihood of the user executing the one or more responsive events.

15. The method of claim 11, wherein the action is one or more of: executing the logic data structure, modification of the logic data structure, voiding the logic data structure, or creating a new logic data structure.

16. The method of claim 15, wherein the constraints include a verification of the information in the additional blocks including the user specific value by the one or more of the plurality of second computing systems or the first computing system.

17. The method of claim 1, further comprising:
generating, via the application of the one or more of the plurality of second computing systems or the first computing system, new blocks in the cryptographically verifiable ledger including information associated with one or more responsive events.

18. The method of claim 17, wherein the constraints include a confirmation of the execution of the one or more responsive events by the one or more of the plurality of second computing systems or the first computing system.

19. The method of claim 11, wherein the one or more of the plurality of second computing systems or the first computing system are configured to predict the user specific value using a predictive analysis based on the information in the first block, second block and the subsequent blocks.

20. The method of claim 19, wherein the one or more of the plurality of second computing systems or the first computing system are configured to predict the user specific value each time each subsequent block is generated.
